(19) United States
(12) Patent Application Publication
(10) Pub. No.: US 2007/0298381 A1
(43) Pub. Date: Dec. 27, 2007

(54) Dental product for temporary teeth coloring and coverage

(75) Inventor: Lisa Collodoro, Guttenberg, NJ (US)

Correspondence Address: KRAMER & AMADO, P.C., 1725 DUKE STREET, SUITE 240, ALEXANDRIA, VA, 22314, US

(73) Assignee: Gaia Via, LLC, Gutenberg, NJ (US)

(21) Appl. No.: 11/806,293

(22) Filed: May 31, 2007

Related U.S. Application Data
(60) Provisional application No. 60/810,164, filed on Jun. 2, 2006.

(51) Int. Cl. A61C 5/00; A61C 13/225

(52) U.S. Cl. 433/215; 433/180

(57) ABSTRACT

A temporary dental product for teeth coloring and teeth coverage is provided. The temporary dental product includes a solid tooth veneer which has cervical, proximal and incisal edges. An adhesive substance forms a bond between the veneer and a user's actual tooth to secure the tooth veneer in place without physically altering the tooth. The veneer is removable at the discretion of the user after a temporary period. Colors of the veneer are selected by the user and include various shades of white. Color modifiers may be added to the surfaces of the veneer or to the adhesive to achieve the desired outward color of the veneer. Single or multiple veneers may be used at the same time. Methods of using the dental product are also provided.

The present invention relates to a dental product, for temporary use, which alters the color, size and shape of an individual's teeth, and more particularly to a temporary dental product which can be applied by the individual user or dental professional.

### BACKGROUND

There are many teeth whitening and bleaching products on the market at present. These include various toothpastes, rinses, bleaching strips and trays, and other over the counter products, however, these often produce undesirable and unpredictable results. The bleaching/whitening process is required to be repeated frequently which adds significant cost to the individual. Other methods include more invasive procedures such as bridge-work and laminates which are expensive and usually involve a physical preparation of the person's teeth which is irreversible. A need exists for a coloring and cosmetic product which can provide consistent, reliable results without permanently altering the teeth in a physical manner.

### SUMMARY

The present invention overcomes the above mentioned disadvantages by providing a dental product that includes a tooth veneer having a cervical edge, an incisal edge, and a pair of proximal edges where the veneer can be temporarily bonded to a natural tooth surface with a temporary adhesive. The words “temporary adhesive” should be understood to include semi-permanent adhesives as well as temporary adhesives. The present invention is a temporary dental veneer for attachment to the labial enamel surfaces of anterior teeth or labial surfaces which have had other restorative dentistry, such as permanent veneers or crowns. The veneer is placed on a tooth having an undesirable appearance in order to alter the appearance of the tooth by displaying a different color, size, or shape than the underlying tooth. In the present invention, the tooth veneer is made from a polymer material which is non-toxic and non-water soluble, and preferably from an ethyl cyanoacetate based polymer. The tooth veneer is preferably formed from either a prefabricated mold or a customized mold of a patient's mouth. In the dental product of the present invention, the veneer is preferably a solid unitary piece and has a thickness from approximately 1/10 of a millimeter to 2/10 of a millimeter. The veneer may be thickest at the center point and is thinnest at the pair of proximal edges, at the incisal edge, and at the cervical edge to resemble a natural tooth's contour. In one embodiment, the veneer may have an approximate uniform thickness throughout the veneer.

In the present invention, multiple tooth veneers may be used by an individual at the same time. In this manner, a second or multiple veneer(s) each having a cervical edge, an incisal edge, and a pair of proximal edges and each capable of temporarily bonding to a second or different tooth surface with a temporary adhesive are used simultaneously by an individual with the first veneer.

In an alternative embodiment of the present invention, the temporary veneer has a bottom surface and a bottom rim extends lingually from the bottom surface at the incisal edge for strength and support of the cover piece.

When in use, the dental product of the present invention covers the entire surface of the tooth. This is achieved when the cervical edge of the veneer preferably aligns with the cervical edge of the tooth of the user. The temporary veneer may be applied by the user or the dental professional and is likewise removable by either person. The temporary veneer remains on the tooth of the user for preferably up to seven days, but may be used for less than one day or even one hour. The dental product of the present invention may be produced in pre-selected colors or color enhanced through the use of color modifiers. Preferably, the colors are multiple shades of white. The color is chosen from a shade guide provided to the individual. With one embodiment of the present invention, a user selects a desired color, size and shape for the veneer.

The dental product of the present invention includes a veneer having a bottom surface which receives the adhesive to form a temporary bond with the surface of the tooth. With the present invention, the temporary adhesive used may be clear or opaque. A clear adhesive is used to reflect the color of the natural tooth and an opaque adhesive is used to block the color of the natural tooth. The adhesive may be a gel, a liquid, or a paste.

In a preferred embodiment, a color modifier is used to enhance the color of the tooth. The color modifier may be applied on the inside or outside of the veneer, or mixed into the adhesive. The veneer is then pressed onto a selected tooth. As the veneer is translucent, the color of the veneer which is displayed during use is the color of the underlying adhesive with the color modifier. The appearance of an individual's teeth is thereby altered temporarily while using the veneer. Various combinations of color modifiers may be used with various colored veneers.

In another alternative embodiment of the invention, there is provided a temporary veneer which includes the temporary adhesive material already provided on the rear side of the temporary veneer. In this embodiment, the adhesive material is covered by a removable backing. The user or dental professional removes the backing to expose the adhesive and then presses the veneer onto a selected tooth. In this manner, the rear side of the veneer with the exposed adhesive bonds onto the surface of the selected tooth. The adhesives may include the color modifiers described previously.

The present invention also provides a method of altering the physical appearance of a tooth. The method includes the steps of selecting a tooth with an undesirable appearance and then selecting a tooth veneer with a desirable appearance, preferably based on size, shape, or color choices. In the method of the present invention, the user then applies adhesive to the bottom surface of the selected veneer and presses the veneer with the adhesive onto the selected tooth to temporarily alter its appearance. The veneer may be removed by the user as desired.

In the method of the present invention, the veneer alters the appearance of the tooth by displaying a different color than the tooth or by coverage of an undesirable area of the tooth. In the method of the present invention, the veneer is made from a polymer material which is non-toxic and non-water soluble, preferably an ethyl cyanoacetate based polymer. With the method of the present invention, the veneer preferably has a thickness from 1/10 of a millimeter to 2/10 of a millimeter. Additionally, as mentioned above, the veneer has a center point and may be thickest at the center point. In an embodiment of the method, the veneer may be thinnest at the pair of proximal edges, at the incisal edge, and at the cervical edge. In one embodiment, the veneer has an approximate uniform thickness throughout the veneer. Molding techniques are used to form the veneer of the method of the present invention.

With the method of the present invention, it includes an embodiment where at least a second veneer, and preferably multiple veneers are used simultaneously by an individual with the first veneer. In this embodiment, each of the additional veneers has a cervical edge, an incisal edge, and a pair of proximal edges and is temporarily bonded to another tooth surface with an adhesive.

In an alternative embodiment of the method of the present invention, the veneer has a bottom rim extending from the bottom surface. In each of the embodiments of the methods of the present invention it is preferable that the cervical edge of the veneer is aligned with a cervical edge of the tooth of the user in order to provide the cosmetic effect.

In the methods of the present invention, the veneer is applied by the user or the dental professional and can be removed by either the user or the dental professional. In the methods of the present invention, the veneer remains on the tooth of the user for at least one hour, or one day, and preferably up to seven days. In the methods of the present invention, the veneer is produced in pre-selected colors or with color modifiers applied to the veneer, preferably in multiple shades of white.

In yet another embodiment, the veneers of the present invention are shaped to cover an exposed cervical root area of a tooth for individuals who suffer from a receding gum line. The extended tooth cover is similar to those described previously, but extends cervically/apically above the cervical edge to cover the exposed root (ie, the missing gum section). The temporary veneer is bonded to the tooth with adhesive materials as described previously. The extended area is colored a desired shade of pink, red, or a shade which corresponds to the user's gum color in order to cosmetically blend the veneer into the gum line. The veneer itself may be colored in sections to correspond to the desired color of the tooth and gum, or color modifiers may be used with the adhesives, or a combination of colors added to the veneer and color modifiers added to the adhesive. Removable backings may also be placed on the adhesive area in this embodiment.

The present invention also provides for a kit which includes veneers for each of the various shapes of teeth, such as centrals, laterals, cuspids, and bicuspids as well as the various items and instructions necessary for proper application of the veneers. These items include adhesives and applicators/brushes, files and shaping tools to shape the veneers, handling sticks, an LED light for curing the adhesive, color modifiers, and graphite/plastic scalers to remove any residual adhesive. The dental professional or users therefore have a convenient pre-packaged kit to create tooth coloring and coverage for individuals.

### BRIEF DESCRIPTION OF THE DRAWINGS

FIG. 1 is a front view of the present invention.

FIG. 2A and 2B are rear views of alternative embodiments of the present invention.

FIGS. 3A and 3B are side views of alternative embodiments of the present invention.

FIGS. 4A and 4B are illustrations of the present invention as applied to an individual's teeth.

FIG. 5 is an illustration of the present invention in use on an individual's teeth.

FIG. 6 illustrates an embodiment of the present invention with a removable backing.

FIGS. 7A and 7B illustrates an embodiment of the present invention to cover an exposed root of a tooth.

FIG. 8 is an alternative embodiment of the present invention which uses a tray shape.

### DETAILED DESCRIPTION

The present invention provides for a dental product and methods of using the dental product which allows temporarily changing the color, size, and shape of an individual's teeth in a cost effective manner without physically altering the teeth. The present invention is a cosmetic temporary veneer which is attached to a single human tooth by a non-permanent adhesive type material. A plurality of veneers can be used to color and/or cover multiple teeth at a single time. Each veneer is shaped and fitted for a particular tooth, and preferably made from a polymer based material. The color of each veneer can be chosen by the person or the person's dentist from multiple pre-selected colors and shades. The dental professional or the user presses the veneer with the adhesive onto the selected tooth to temporarily alter its appearance. The veneers are able to remain on the teeth for a period of several hours and up to one week and can be removed by simply pulling the tooth cover off the individual tooth.

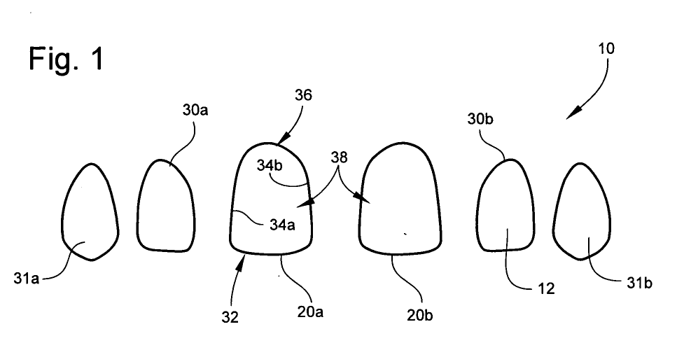

Referring to FIG. 1, there is shown the present invention 10 which includes one or more individual veneers 12. The individual veneers 12 may include central incisor veneers 20a and 20b, lateral incisor veneers 30a and 30b, as well as cuspid veneers 31a and 31b. In the present invention 10, each of the individual veneers 12 have an incisal edge 32, a pair of proximal edges 34a and 34b, and a cervical edge 36. The height and width of the veneers 12 are within the known ranges for adult human teeth, especially the known dimensions for upper central incisors, laterals, cuspids and bicuspids. Heights ranging from 6 millimeters to 13 millimeters and widths of 6 millimeters to 11 millimeters are typical. As described more below, each of the veneers 12 are produced and sized to fit appropriately over an individual's tooth for coverage and coloration.

In FIG. 1, the labial surface 38 of the individual veneer 12 is shown and may either be a flat or convex curved surface to simulate the external-facing surface of an individual's tooth. Preferably, the individual veneers 12 are made of a polymer material, such as an ethyl cyanoacetate based polymer or other suitable polymer material which can be used inside the mouth of an individual. The polymer material is a translucent material. In the present invention, various pre-selected colors of the polymer material are available for the desired color of the individual veneers 12. The individual or the dental professional has the ability to select the desired color based upon shade guides known in the art, such as the Vita Pan Classical Shade guide which gives a range of colors such as whites, yellows, grays, and browns. Color modifiers, such Kerr Color Plus, can also be applied to the surface of the veneer 12.

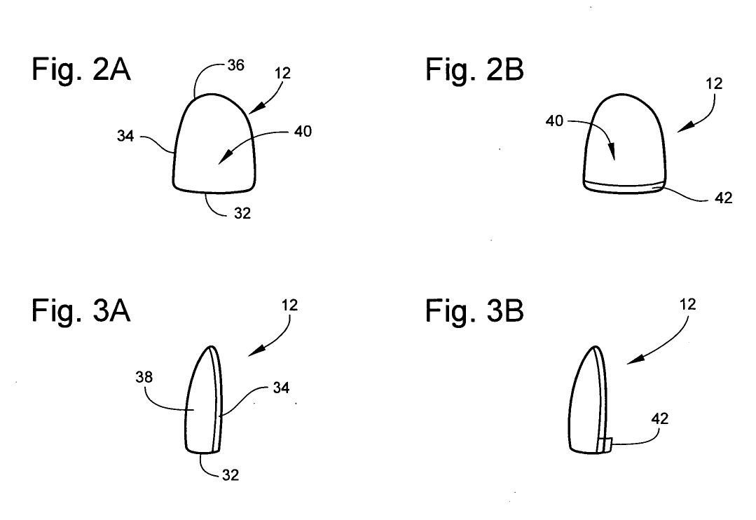

Referring to FIG. 2A, there is shown a rear view of the present invention 10. The rear surface 40 may be flat or concave in shape to fit over the external-surface of an individual's teeth. The rear surface 40 also provides the surface for receiving the adhesive material which is used to temporarily bond the veneer 12 to an individual's tooth. FIG. 2B provides for an alternative embodiment of the present invention 10 where the incisal edge 32 has a bottom rim 42 extending from the bottom surface 40. The bottom rim 42 provides for additional strength and support of the veneer 12 when the veneer 12 is in place and in use on an individual's tooth.

FIGS. 3A and 3B illustrate side views of the veneers 12 of present invention 10. In FIG. 3A, the incisal edge 32 and the proximal edge 34 are shown with top surface 38. The veneers 12 preferably have a thickness from approximately 1/10 th of one millimeter to approximately 2/10 ths of one millimeter. The thinnest areas of the veneers 12 maybe less than 1/10^{th} of a millimeter. Preferably, the veneers 12 are thinnest at the incisal 32, cervical 36, and proximal edges 34 and thickest in the center of the veneer 12. FIG. 3B illustrates the alternative embodiment described in FIG. 2B with bottom rim 42 extending from the incisal edge 32 and preferably, following the outline of the incisal edge 32. Preferably, the bottom rim 42 is approximately 2 millimeters and up to 6 millimeters. Preferably, the bottom rim 42 is a single formed piece with the veneer 12 and formed by known molding techniques. When in use, this bottom rim 42 protects and covers the cutting surface of a person's actual tooth.

In order to make individual veneers 12, the manufacturing process requires molds of individual human teeth from an adult human mouth. The mold may be a mass produced generic mold which is made in a variety of sizes, such as central incisors, lateral incisors, and cuspids that are of typical dimensions for an adult human set of teeth. Alternatively, a customized mold may be produced for each individual patient by taking an impression of the patient's mouth. The impression is then poured and dried to make the mold through methods known in the art.

Overall, the manufacture of molds may be completed by standard plastic mold filling or injection molding techniques known in the art. Veneers 12 which are manufactured and cut from films or sheets of material are also within the embodiments of the present invention. As described above, the material used for creating the individual veneers is preferably a non-toxic, non-water soluble polymeric material, such as an ethyl cyanoacetate based material or other suitable plastic which may be approved for use in the mouth.

Molds may also be made for each type of tooth. The veneers 12 are therefore able to be individually mass produced according to the particular tooth—centrals, laterals, cuspids or bicuspids. The individual veneers 12 can be further shaped and filed either at the dentist's office or by the individual at home. The edges and corners may be filed, sanded, or polished to achieve the desired shape whether it is for front teeth, incisors, cuspids or bicuspids.

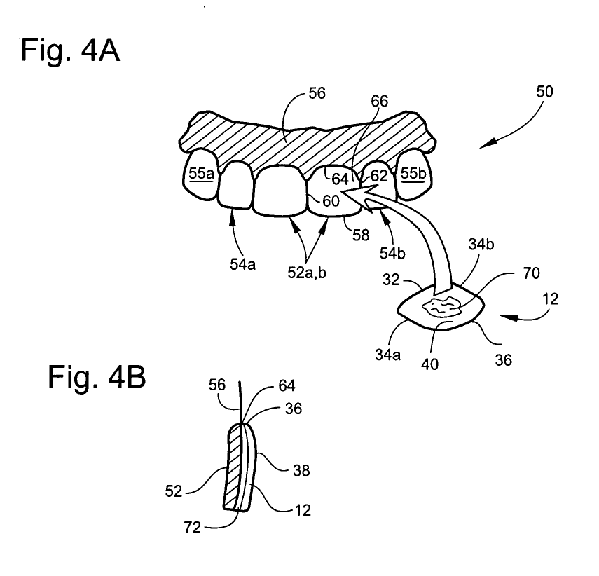

In FIG. 4A and 4B, there is illustrated the present invention in use. In FIG. 4A, there is shown a mouth 50 of an individual with two upper central teeth 52a and 52b and a pair of upper lateral incisor teeth 54a and 54b adjacent to respective upper central teeth 52a and 52b. Cuspids 55a and 55b are adjacent to lateral teeth 54a and 54b respectively. Above the teeth 52, 54, and 55 is the gum 56 of the mouth 50. As shown with reference to single tooth 52b, each of the teeth 52a, b, 54a, b, and 55a, b have an incisal edge 58, a pair of proximal edges 60 and 62 and a cervical edge 64. Each tooth 52a, b, 54a, b and 55a, b also has a frontal surface, such as frontal surface 66 on tooth 52b. Also shown in FIG. 4A is a veneer 12 with an amount of glue or adhesive 70 on the bottom surface 40 of the individual veneer 12.

The adhesive 70 may be from a typical temporary dental adhesive known in the art and may be dispensed onto the bottom surface 40 of veneer 12 by known methods in the art, such as dispensers or brushes. The adhesive 70 is selected from known temporary adhesives which are approved for use in the mouth of humans and may be in the form of a liquid, paste, or gel. The term “temporary adhesive” should be understood to include semi-permanent adhesives, as well as temporary adhesives, which form non-permanent bonds. Commercially available light cured glues, such as Kerr Temp Bond Clear, would also work with the present invention. Adhesives which include fluoride may be used, as well as medicinal grade cyanoacrylate approved for use in the mouth. A quantity of adhesive sufficient for bonding the veneer 12 to the tooth surface 66 is required for each veneer 12, usually one to a few drops of the adhesive 70. Bonding time for non-light cured adhesives may vary according to manufacturer. Light cured adhesives bond in less than a minute. The adhesives with the present invention 10 may be clear, opaque, or white in color to aid in the desired cosmetic effect from the veneers 12. A clear adhesive allows for the underlying actual tooth color to reflect more readily through the veneer 12 than an opaque or white adhesive.

A color modifier may also be added to the adhesive 70. Particularly, Kerr Kolor+Plus color modifier when added to Kerr Temp Bond Clear adhesive is preferred. The Kerr Kolor+Plus color modifier has a wide selection of color choices and all are suitable for use with the present invention. In this manner, a veneer 12 with Kerr Temp Bond Clear adhesive on the rear surface 40 which has the desired color modifier of Kerr Kolor Plus added to the adhesive 70 in a desired amount provides the desired cosmetic appearance and color when the veneer 12 is placed onto a tooth, such as tooth 52b. This occurs because the veneer 12 is preferably translucent and the outward appearance of the veneer 12 is altered due to the color of the underlying adhesive 70 with the color modifier. By varying the amount of color modifier added to the adhesive 70, the outward appearance of the veneer 12 is altered. Similarly, different colors are obtained my selecting different color modifiers (ie, whites, grays, yellows, browns, decorative, or combinations thereof). Shade guides can be used as before for assistance in color selection. The individual user or dental professional can add the modifier or the modifier is pre-made in various colors.

In FIG. 4A, an individual veneer 12 with the adhesive 70 on the bottom surface 40 is pressed onto the surface 66 of a tooth, such as upper front tooth 52b. As the veneer 12 is placed onto the tooth 52b, the user matches the edges 32, 34a, 34b, and 36 of the veneer 12 with the respective edges 58, 60, 62, and 64 of the actual tooth 52b. In this manner, the cervical edge 36 of the veneer 12 meets with the cervical edge 64 of the actual tooth 52b and provides for alignment of the cervical edge 36 of the veneer 12 with the gum 56. Likewise, the proximal edges 34a and 34b of the veneer 12 align with the proximal edges 60 and 62 of the actual tooth 52b. The incisal edge 32 of the veneer 12 may be aligned with incisal edge 58 of the tooth 52b if so desired.

FIG. 4B illustrates a side view of a tooth 52 with a veneer 12 bonded on top of the tooth 52 with an adhesive layer 72 formed between. The veneer 12 is shown in alignment with gum 56 where the veneer cervical edge 36 and tooth cervical edge 64 meet at a single point. As shown in FIG. 4A and 4B, when the veneer 12 with adhesive 70 is pressed on to the actual tooth 52, the adhesive disperses across the bottom surface 40 of the veneer 12 and the tooth surface 66. This forms the layer 72 of adhesive with a thickness of approximately plus or minus 1/10 th of a millimeter, and preferably as thin as possible but of sufficient thickness to form a temporary bond.

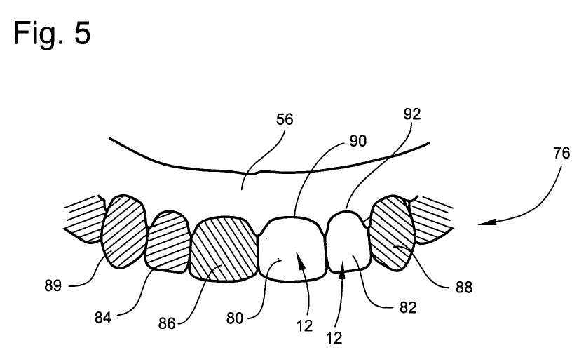

As shown in FIG. 5, a plurality of veneers 12 may be applied to several teeth at once to provide a user with the desired appearance. In FIG. 5, there is shown the upper dental line 76 of a user's mouth with teeth 80, 82, 84, 86, 88, and 89. Teeth 80 and 82 each have a veneer 12 placed and secured over the teeth 80 and 82 with a temporary adhesive. That is, a first veneer 12 is placed on upper central tooth 80 and a second veneer 12 is placed on a second tooth—adjacent upper lateral incisor tooth 82. However, teeth 84, 86, 88, and 89 do not have a cover piece placed over their respective surfaces and are discolored, stained, darker, or considered undesirable in appearance for some reason by the user. The undesirable appearance is illustrated in FIG. 5 by the shading and hatch marks on teeth 84, 86, 88, and 89. Teeth 80 and 82 with veneers 12 in place provide a desirable visual appearance. Preferably, the cervical edges 90 and 92 of the veneers 12 meet with the gum 56 to form a natural, uniform appearance. The desired veneers 12 are chosen previously by the user or dentist from a variety of colors, shapes or sizes. The colors are chosen from the Vita shade guide to achieve color matching. It should be appreciated that in this manner, separate veneers 12 may be placed or pressed onto each of teeth 84, 86, 88, and 89 with temporary adhesive to alter the appearance and color of these teeth as desired by the user for a temporary period of time. The veneers may be used with anteriors, laterals, cuspids, and bicuspids.

The veneers 12 may remain on the user's teeth for a period of a one hour, (or even less) and up to approximately one week. If desired, the veneers may be worn for less than one day. For removal, the individual user can simply pull the veneers 12 off from their teeth using their own finger tips. The individual user may clean or brush their actual teeth to remove any remaining adhesive residue. If needed, a plastic or graphite scraping tool may also be used to remove adhesive material which remains on the user's teeth. The tooth covers 12 are reusable if not damaged and may be cleaned by a scraping tool to remove remaining adhesive.

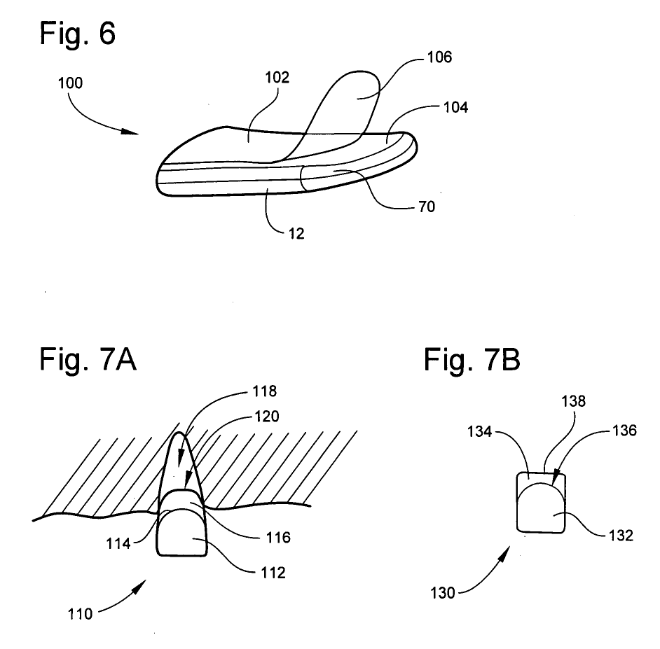

As shown in FIG. 6, in another embodiment of the present invention 100, the veneer 12 has an adhesive material 70 deposited on the rear surface of the tooth cover during production. The veneers 12 are translucent and may be made from pre-selected colors as described previously. The adhesive material 70 in this embodiment may include the color modifiers described above already added to the adhesive 70 to provide the desired color characteristics. The color modifiers can also be applied directly to the inner or outer surfaces of the veneer 12. On top of the adhesive material 70, the invention 100 in this embodiment has a removable backing material 102 covering the adhesive material 70. The removable backing material 102 may be made from film, cloth, paper, or other suitable materials in the art which is placed onto the adhesive material after the adhesive material is deposited. The removable backing 102 can be peeled away from the surface 104 of the adhesive 70. In application, the user or dental professional removes the backing 102 to expose the top surface 104 of the adhesive 70 and then presses the temporary veneer 12 onto a selected tooth as shown previously with FIG. 4A. In this manner, the rear side of the veneer with the exposed adhesive 70 bonds onto the surface of the selected tooth.

An alternative embodiment of the present invention is shown with reference to FIGS. 7A and 7B. One particular dental problem many individuals suffer from is a receding gum line where the root of a tooth is exposed. This problem is illustrated in FIG. 7A which shows a tooth 110 with this condition. The tooth 110 extends into the gum line 120 with the root 118 of the tooth 110 located well within and above the gum line 120. In individuals with a receded gum line, there is an exposed portion 116 of the root located above the normally exposed enamel 112 of the tooth (shown in FIG. 7A as the area above line 114 and below gum line 120. As shown in FIG. 7B, the veneers 130 of the present invention are made to cover this exposed root area 116. The veneer 130 in this embodiment is similar to those described previously, but also includes an extended area 134 to cover the exposed root (ie, the missing gum section) 116 above the area of the tooth when the temporary veneer 130 is bonded to the tooth 110 with adhesive materials. The extended area 134 is colored a desired shade of pink, red, or a shade which corresponds to the users gum color in order to cosmetically blend the veneer 130 into the gum line 120. The veneer 130 may be colored in sections—for example, white to simulate the enamel of the tooth 132 and pink to simulate the gum 134 above a cervical line 136. The coloring of the veneer 130 may be done during production through known coloring techniques, including the use of color modifiers. The user may also apply color modifiers to the veneers inner surface or outer surface to achieve this cosmetic root coverage. Alternatively, the adhesive used on the rear surface of the veneer 130 may be clear on the lower area 132 and pink, red, or the desired shade in color on the upper extended area 134 by use of the color modifiers described previously. As before, the veneer 130 can be filed and shaped by the dental professional or user to match the gum line 120, exposed root 116 and or tooth 112. The removable backing 102 described with respect to FIG. 6 may also be placed on the adhesive and used with this embodiment.

The individual or dental professional uses this embodiment similar to the veneers described previously. The use of this embodiment is more particularly described with reference to FIGS. 7A and 7B together. The veneer 130 having gum extension area 134 and adhesive on the rear of the veneer 130 is pressed onto the tooth 112 with exposed root portion 116. The temporary veneer 130 is aligned on the tooth 112 so that the lower area 132 of the veneer 130 is positioned over the tooth area 112. Similarly, the upper extended gum area 134 of the veneer 130 is aligned over the exposed root 116 and the top edge 138 of the veneer 130 aligns with the gum line 120. As mentioned above, the veneer 130 may be shaped and filed to match the tooth 112 and missing gum area 116. Once the veneer 130 is aligned and pressed onto the tooth 112, the adhesive used forms a bond between the veneer 130 and the tooth 112 as shown previously with FIG. 4A. Similarly, the adhesive on the rear side of upper gum extension area 134 forms a bond with the exposed root 116. When properly aligned, the cosmetic effect is that a uniform gum line is created. At the same time, veneer 130 cosmetically enhances the tooth 112 as described with previously embodiments. This embodiment also provides the added benefit of reducing root sensitivity when the exposed root area is covered by the veneer 130. Removal of the temporary veneer 130 is similar to before.

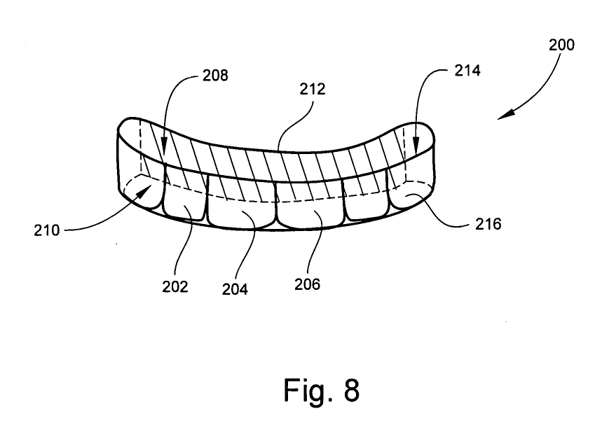

Referring to FIG. 8, there is shown an alternative embodiment of the present invention. In FIG. 8, a temporary dental tray 200 is shown which like the previously described embodiments of the invention 10 provides temporary teeth coloring and covering. The tray 200 is a customized mold made from an impression taken of the individual's teeth. The tray 200 is a single uniform piece shaped for an individual's upper or lower teeth and includes a plurality of teeth shapes 202, 204, and 206 on a front surface 210 of the tray 200. A cavity 208 is formed and defined by a rear wall 212, a front wall 214, and a bottom surface 216. Preferably, the tray 200 is formed from the same polymer materials described above, and preferably from an ethyl cyanoacetate based material. The material for the tray 200 may be supplied in sheets and can be made by using conventional vacuum forming methods or other conventional methods known in the art with the tray shape and design created from molds of a mouth. An individual uses the tray 200 by placing the tray 200 over the their own teeth and thereby aligning tooth shapes such as shaped teeth 202, 204, and 206 over their actual teeth to provide coverage and alteration of the color. Similar to previous embodiments, the color of the tray 200 is chosen by the individual or the dental professional from various pre-selected colors. Shade guides may also be used to assist in the color selection process. The user may remove the tray 200 after a desired amount of time.

In the present invention, all of the components for the individual or dental professional to perform the temporary teeth alteration may be combined into a convenient kit. The contents of the kit includes: tooth veneers 12 for each of the various shapes of teeth, such as centrals, laterals, cuspids, and bicuspids; adhesives, applicators, and brushes; files and shaping tools to shape the veneers 12; handling sticks, such as commercially available Veneer Styx; an LED light for curing the adhesive; color modifiers; and plastic or graphite scalers to remove excess or residual adhesive. The kit may also include a size and shape guide composed of tooth templates made of a thin material, such as a polymer film. The tooth templates have images of teeth in different shapes and sizes. Each image is perforated for easy removal from the film to use as a guide to size and shape the veneer for a corresponding tooth. Instructions for the proper application and use of the veneers are also included in the kit. Preferably, the veneers are pre-coated with the adhesive and removable backing material as described previously for convenience of the individual or dental professional.

With each of the embodiments of the present invention, the teeth of the individual are not physically or chemically altered. The individual can have the desired results immediately as opposed to having to go through several treatments over an extended time. Similarly, individuals with tetracycline stains or discoloration from personal habits such as smoking, drinking coffee and tea are able to use the present invention to visually improve their appearance. The present invention may also be used by individuals with discolored fillings for coverage of the undesirable areas. In addition to the benefits mentioned above, the tray of the present invention also provides the individual with the ability to color in a missing or chipped tooth to hide an undesirable physical appearance.

What is claimed is:

1. A dental product comprising,
a tooth veneer having a cervical edge, an incisal edge, and a pair of proximal edges, the tooth veneer capable of temporarily bonding to a tooth surface with a temporary adhesive without altering the tooth surface.

2. The dental product of claim 1, wherein the veneer is made from a polymer material.

3. The dental product of claim 1 wherein the veneer has a thickness from 1/10 of a millimeter to 2/10 of a millimeter.

4. The dental product of claim 1 further comprising a second veneer having a cervical edge, an incisal edge, and a pair of proximal edges, the second veneer capable of temporarily bonding to a second tooth surface with a temporary adhesive, the second veneer used simultaneously by an individual with the first veneer.

5. The dental product of claim 1 wherein the veneer has a bottom surface and a bottom rim extends from the bottom surface.

6. The dental product of claim 1 wherein the veneer is applied by the user or dental professional.

7. The dental product of claim 1 wherein the veneer remains on the tooth of the user for a period of from one hour up to seven days.

8. The dental product of claim 1 wherein the veneer is produced in pre-selected colors.

9. The dental product of claim 1 wherein the veneer is a color chosen from a shade guide.

10. The dental product of claim 1 wherein the veneer has a bottom surface which receives the adhesive to form a temporary bond with the surface of the tooth.

11. A temporary tooth veneer comprising,
a solid unit with a cervical edge, an incisal edge, a pair of proximal edges and a bottom surface for receiving an adhesive to form a temporary bond with a tooth.

12. A method of altering the appearance of a tooth comprising,
selecting a tooth with an undesirable appearance;
selecting a veneer with a desirable appearance, said veneer having a bottom surface;
applying adhesive to the bottom surface of the veneer; and
pressing the veneer with the adhesive onto the selected tooth to temporarily alter the appearance of the selected tooth.

13. The method of claim 12, wherein the veneer is made from a polymer material.

14. The method of claim 12, wherein the veneer has a thickness from 1/10 of a millimeter to 2/10 of a millimeter.

15. The method of claim 12 further comprising a second veneer having a cervical edge, an incisal edge, and a pair of proximal edges, the second veneer capable of temporarily bonding to a second tooth surface with an adhesive, the second veneer used simultaneously by an individual with the first veneer.

16. The method of claim 12 wherein the veneer has a bottom rim extending from the bottom surface.

17. The method of claim 12 wherein the veneer is applied by the user or dental professional.

18. The method of claim 12 wherein the veneer remains on the tooth of the user for up to seven days.

19. The method of claim 12 wherein the veneer is produced in pre-selected colors.

20. The dental product of claim 10 further comprising a removable backing placed on the adhesive.

21. The dental product of claim 1 further comprising a gum extension section extending from the cervical edge of the veneer.

22. The dental product of claim 1 wherein the veneer is translucent.

23. A temporary veneer comprising,
a solid unit with a cervical edge, an incisal edge, a pair of proximal edges and a bottom surface;
an adhesive on the bottom surface to form a temporary bond with a tooth; and
a removable backing on the adhesive.

24. A kit comprising,
at least one tooth veneer having a cervical edge, an incisal edge, and a pair of proximal edges, the tooth veneer capable of temporarily bonding to a tooth surface with a temporary adhesive without altering the tooth surface; and
an adhesive.

25. The kit of claim 24 further comprising a guide having tooth templates for sizing and shaping the veneer.
